(19) United States
(12) Patent Application Publication
(10) Pub. No.: US 2006/0248183 A1
(43) Pub. Date: Nov. 2, 2006

(54) Programmable notifications for a mobile device

(75) Inventor: Sally Barton, Seattle, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/116,860

(22) Filed: Apr. 28, 2005

(51) Int. Cl. G06F 15/173

(52) U.S. Cl. 709/224

(57) ABSTRACT

A method, computer-readable medium, and a computing device enable a user or other entity to select and/or customize alerts that can be triggered based on a notification event to thereby improve the ability of a mobile device to assist the user in distinguishing between multiple notification events. A user can create one or more separate and independent profiles for use with a mobile device. The user can preemptively control call interruptions and/or provide a type of alert used by the mobile device to inform the user of a particular notification event.

### BACKGROUND OF THE INVENTION

As society moves forward, mobile devices, such as mobile telephones, smart phones, personal data assistants (PDAs), and the like are being used and depended upon more and more in everyday life. These devices typically include one or more notification mechanisms, such as a vibration device, haptic device, alarm, ringer, visual indicators, various alert tones, etc. The notification mechanisms are typically used to notify a user of any number of events such as: an upcoming meeting, wake-up call, birthday, anniversary, incoming call, missed call, voicemail, text message, etc.

However, due to the rich content associated with these mobile devices, it can be difficult for a user to entertain multiple notifications at one time without distracting or an annoying the user. Multiple notifications within a short period of time can overwhelm a user, making for a less favorable experience when using the mobile device. Moreover, by providing multiple notifications, it becomes more probable for a user to overlook or miss important and other events, which is typically not acceptable. For example, a user may not know that a scheduling application is providing an appointment reminder during a cellphone conversation because the cellphone is next to the user's ear, making the screen less noticeable. Additionally, it tends to be difficult for a user to distinguish various device notifications during a call. Furthermore, unless the device is in a vibrate or haptic mode, the notifications are typically audible and repeat, which tend to interfere with a phone call.

It is with respect to these considerations and others that the various embodiments of the present invention have been made.

### SUMMARY OF THE INVENTION

The present invention is directed to a method, computer-readable medium, and a computing device operable to enable a user or other entity to select and/or customize alerts that can be triggered based on a notification event. The present invention improves the ability of a mobile device to assist the user in distinguishing between multiple notifications. Embodiments of the present invention provide a method, computer-readable medium, and a computing device which allow a user to create one or more separate and independent profiles directed to one or more notification events for a mobile device. For each notification event, the user can preemptively control call interruptions and/or provide a type of alert used by the mobile device to inform the user of a particular notification event.

According to embodiments of the invention, using the mobile device's user interface, a user can select various alert settings according to the type of notification event. In alternative embodiments, the alert settings may be devised on another computing device running one or more similar applications and pushed to or pulled from the mobile device. For example, a user can select sounds, vibrating feedback, haptic feedback and/or combinations thereof, based on the particular notification event. In certain embodiments of the invention, a user can create a custom vibrate and/or haptic pattern. Thus, a user can prescribe highly customized alerts, even down to specific vibrate and/or haptic patterns for notification events and/or for contacts.

The invention may be implemented as a computer process or method, a computing apparatus, or as an article of manufacture such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. These and various other features, as well as advantages, which characterize the present invention, will be apparent from a reading of the following detailed description and a review of the associated drawings.

### BRIEF DESCRIPTION OF THE DRAWINGS

FIG. 1 is a schematic diagram illustrating functional components of an illustrative mobile device for implementation of various embodiments of the present invention.

FIG. 2A is a flow diagram illustrating an embodiment of the invention.

FIG. 2B is a flow diagram illustrating an embodiment of the invention.

FIG. 3 depicts an exemplary in-call experience of a user using a mobile device.

FIG. 4 depicts an exemplary mobile device including an ambient noise detector.

FIG. 5 depicts a mobile device including an exemplary vibration device.

FIG. 6 depicts a mobile device including an exemplary haptic device.

### DETAILED DESCRIPTION OF THE PREFERRED EMBODIMENT

The present invention is described in the context of mobile computing devices (hereinafter “mobile device”), such as personal data assistants (PDAs), cellphones, pagers, smart phones, smart personal objects, camera phones, etc. Embodiments of the present invention provide a mobile device operable to enable a user or other entity to select and/or customize what alerts are triggered when a notification event happens during a call or when the mobile device is otherwise busy. A user can create a separate and independent profile for use with the mobile device. For a type of notification event (e.g. incoming call, multimedia message service, short message service, instant message, voice message, text message, e-mail message, meeting reminder, page, message with attachment, message from a particular contact, information associated with a contact, emergency alert, etc.), the user can preemptively control call interruptions and/or provide a type of notification used by the mobile device to inform the user of a particular notification event. For example, using the mobile device's user interface, a user can select various alert settings according to the type of notification event. In alternative embodiments, the alert settings may be devised on another computing device running a similar application and pushed to or pulled from the mobile device. For example, a user can select sounds, vibrating feedback, haptic feedback and/or combinations thereof, based on one or more notification events. In certain embodiments of the invention, a user can create a custom vibrate and/or haptic pattern. Thus, a user can prescribe highly customized alerts, even down to specific audio, vibrate, and/or haptic patterns for notification events and contacts.

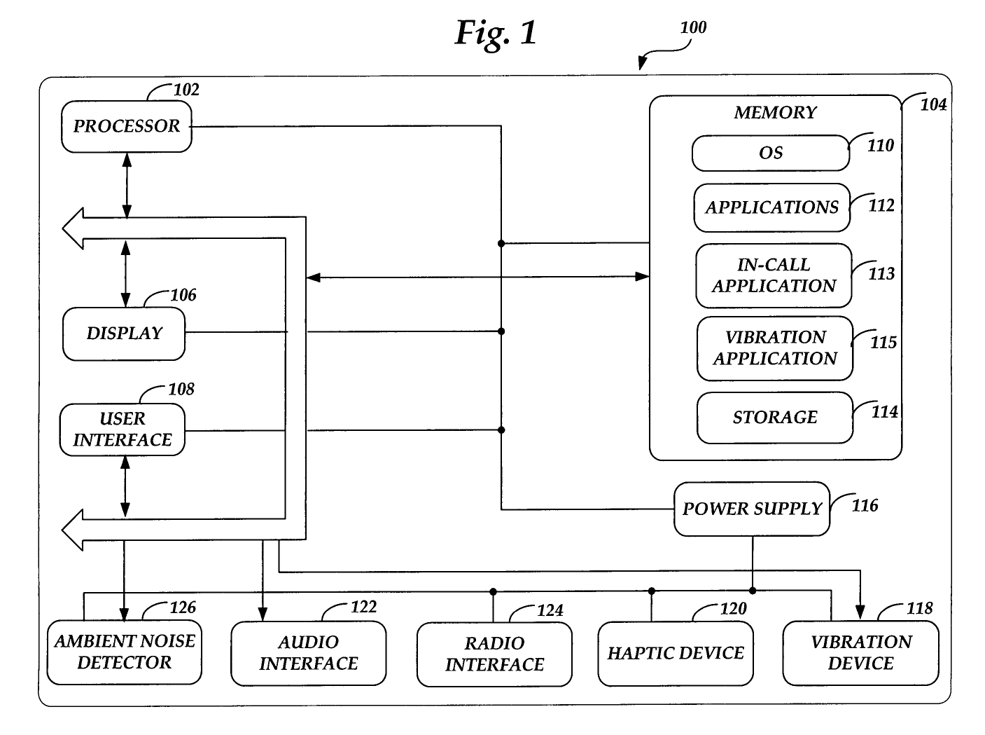

Referring now to the drawings, in which like numerals represent like elements, various aspects of the present invention will be described. In particular, FIG. 1 and the corresponding discussion are intended to provide a brief, general description of a suitable computing environment in which embodiments of the invention may be implemented. While the invention will be described in the general context of program modules that execute in conjunction with program modules that run on an operating system, those skilled in the art will recognize that the invention may also be implemented in combination with other types of computer systems and program modules.

Generally, program modules include routines, programs, applications, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

“Computer readable media” can be any available media that can be accessed by client/server devices. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by client/server devices.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are included within the scope of computer readable media.

The term “content” can be any information that may be stored in an electronic device. By way of example, and not limitation, content may comprise graphical information, textual information, and any combination of graphical and textual information. Content may be displayable information or auditory information. Auditory information may comprise a single sound or a stream of sounds.

Operating Environment

The exemplary operating environment shown and described herein is an example of a suitable operating environment and is not intended to suggest any limitation as to the scope of use or functionality of the invention. Other well known computing systems, environments, and/or configurations that may be suitable for use with the invention include, but are not limited to, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

With reference now to FIG. 1, a schematic diagram illustrating functional components of an illustrative mobile computing device or mobile device 100 is shown. The mobile device 100 has a processor 102, memory 104, display 106, and a user interface 108. The memory 104 generally includes both volatile memory (e.g., RAM) and non-volatile memory (e.g., ROM, Flash Memory, or the like). The electronic device 100 includes an operating system 110, such as WINDOWS MOBILE operating system from MICROSOFT CORPORATION or another operating system, which is resident in memory 104 and executes on the processor 102. The user interface 108 may be a series of buttons, soft keys, a numeric dialing pad (such as on a typical telephone), or another type of user interface means. The display 106 may be a liquid crystal display, a multiple bit display, or a full color display or any other type of display used in mobile devices. In one example, a touch-sensitive display 106 can be used as an input device.

One or more applications 112 can be loaded into memory 104 and run on the operating system 110. Exemplary applications 112 include phone dialer applications, e-mail applications, word processing applications, spreadsheet applications, database applications, scheduling/calendaring applications, contact applications, task applications, browser applications, and so forth. As described further below, it is preferred for certain embodiments that the mobile device 100 also includes an in-call application 113 and/or a vibration application 115. The mobile device 100 includes a non-volatile storage 114 that is located within the memory 104. The non-volatile storage 114 may be used to store persistent information which should not be lost if the mobile device 100 is powered down. The applications 112 may use and store information in the storage 114, such as e-mail or other messages used by an e-mail application, contact information used by a PIM, appointment information used by a scheduling program, documents used by a word processing application, and the like.

The mobile device 100 has a power supply 116, which may be implemented as one or more batteries. The power supply 116 might further include an external power source, such as an AC adapter or a powered docking cradle that supplements or recharges the batteries. The docking cradle can also be configured to provide communication between one or more networked computing devices.

The mobile device 100 is also shown with various types of external notification mechanisms: a vibration device 118, haptic device 120, and an audio interface 122. These devices may be directly coupled to the power supply 116 so that when activated, they remain on for a duration dictated by the notification mechanism or other control, even though the processor 102 and other components might shut down to conserve battery power. The audio interface 122 is used to provide audible signals to and receive audible signals from the user. For example, the audio interface 122 may be coupled to a speaker for providing audible output and to a microphone for receiving audible input, such as to facilitate a telephone conversation, or as a user interface using voice recognition. As described further below, the vibration device 118 or haptic device 120 can be used to give feedback to the user such as for alerting the user of a newly arrived message and other information. The mobile device 100 can control each alert mechanism independently or in various combinations (e.g., audio, vibration, as well as visual cues).

The mobile device 100 also includes a radio or wireless interface 124 that performs the function of receiving and/or transmitting communications at certain frequencies, such as radio frequency (RF). The wireless interface 124 facilitates wireless connectivity between the mobile device 100 and other communication devices. Transmissions to and from the wireless interface 124 are conducted under control of the operating system 110 or other controller. In other words, communications received by the wireless interface 124 may be disseminated to applications 112 via the operating system 110, and vice versa. It will be appreciated that the mobile device 100 can be coupled, wirelessly, or wireline using a docking cradle for example, to one or more other computers, such as a desktop or server computer. As described further below, the mobile device 100 preferably uses the microphone 126 as an ambient noise detector for detecting ambient audio levels, and setting the volume level of the speaker accordingly through the software 402.

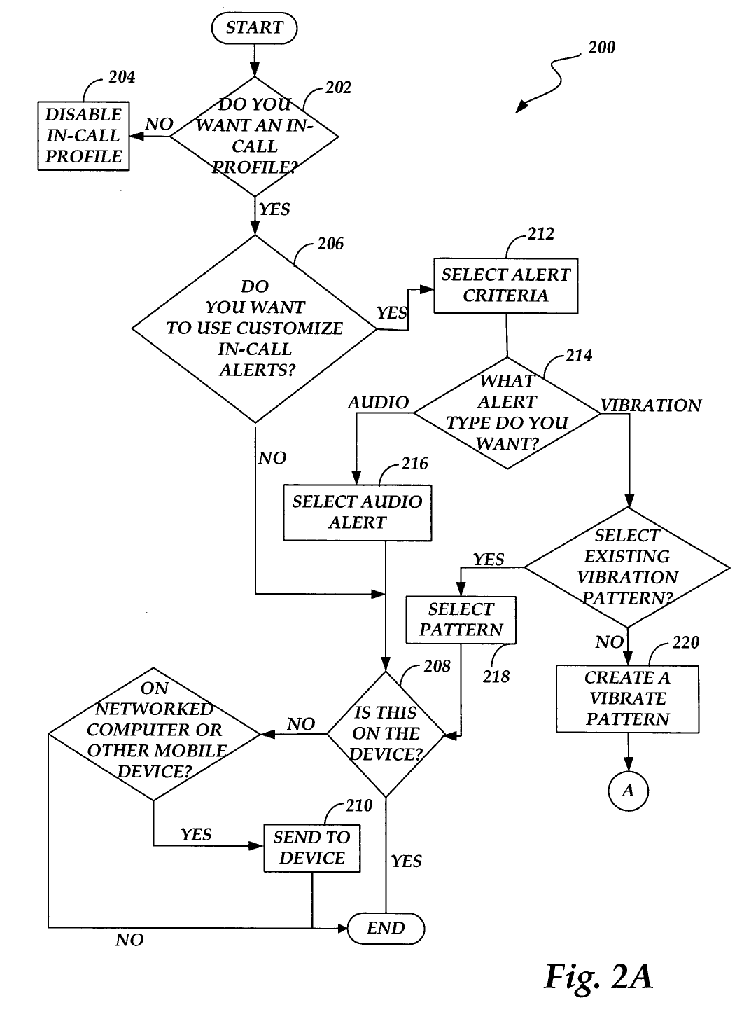

Referring now to FIGS. 2A-2B and with continuing reference to FIG. 1, a flow diagram is depicted which illustrates an embodiment of the present invention. According to this embodiment, a user using the mobile device 100 can create an in-call profile using the user interface 108. The user, using the user interface 108, can bring up a menu for selecting parameters for a particular in-call profile. The user is able to set up multiple in-call profiles and can opt for a preferred in-call profile using the user interface 108.

It will be appreciated that the particular menu is not crucial to the in-call profile set-up, and various combinations of soft-key, button, voice recognition, etc. inputs can be utilized to provide an input means for setting up an in-call profile. The customizable in call profile is preferably automatically activated when a call is placed or received. However, the in-call profile can also be de-activated. The in-call profile also preferably takes priority over a current profile setting. Accordingly, when the in-call profile is activated, the mobile device 100 smartly adapts to the fact that a user is in a call and alerts the user to information or changes in state accordingly. The in-call profile provides the ability for a user to control the way they are informed when different events happen during a call, as described below.

As shown in FIG. 2A, a user, using the user interface 108, can set-up or use one or more in-call profiles via the in-call module or application 113. Alternatively, a user can use a networked computer running a similar in-call application 113 to set up the in-call profile. The in-call profile may then be transferred to the mobile device 100 using a wireline or wireless link, or after a synchronization operation with the networked computer or other mobile device, using ACTIVESYNC by MICROSOFT CORPORATION or another synchronization application, for example.

At 202, the user is prompted to use an in-call profile. If the user does not want to use an in-call profile, at 204 the in-call profile is not activated and the mobile device operates according to current profile settings when in call. If the user does want to use an in-call profile, at 206, the user is prompted to use the default in-call profile or customize a new in-call profile. If the user opts to use the current in-call profile, at 208, the in-call application 200 determines if the current in-call profile resides on the mobile device 100 by checking storage location 114, for example. The mobile device 100 can also query a networked computer or other mobile device for the in-call profile. If the current in-call profile does not reside on the mobile device 100, at 210, the desired in-call profile can be transferred to the mobile device 100 from a networked computer or other mobile device if the in-call profile was created and/or resides on the networked computer or other mobile device. Otherwise, the user is prompted to customize an in-call profile at 206. Preferably, if available, the in-call profile is active unless the user disables the in-call profile.

If the user opts to customize an in-call profile at 206, at 212 the user is prompted to select an alert criteria for the in-call profile. Alert criteria can be assigned/selected according to the communication type or notification event (person or content for example), such as an incoming call, multimedia message service, short message service, instant message, voice message, text message, e-mail message, meeting reminder, page, message with attachment, message from a particular contact, emergency alert, etc. Certain alerts may be assigned audio alerts while in a call, while others may be switched to vibrate or turned off in a call.

For example, at 212 a user may choose an audio alert for a meeting request to alert the user to leave for a meeting in order to be on time. As described below, for certain embodiments, audio alerts emit at an appropriate volume level according to the volume or ambient noise environment associated with a call. At 212 a user may also choose to have a different type of alert associated with an e-mail as compared to an alert associated with an incoming call or a meeting reminder, for example. As further example, at 212, the user can choose to not be informed of a received e-mail during a call, but can choose to be informed of another in-coming call, a meeting reminder, etc. Notifications not shown during the call may alarm at the end of the call.

After selecting the alert criteria, at 214 the user is prompted to select an alert type. According to this embodiment, the user at 216 can select an audio alert from a list of audio alert types. For example, if the user has elected to be notified of incoming calls while in a call, the user can select to be notified by a simulated telephone ring. As another example, the user may choose to receive a three short beeps during a call for meeting reminder. According to this embodiment, at 218 the user can select a vibration pattern for the selected alert type at 212, including combining multiple pulses and pauses for the alert type. For example, the user can select two quick vibrations to be notified of an incoming call during a call. The mobile device 100 preferably includes a variety of vibration and haptic patterns, selectable by intensity frequency, duration, etc.

If the user selects an existing vibration pattern, at 208, the in-call application 113 determines if the selected vibration pattern resides on the mobile device 100 by checking storage location 114, for example. The mobile device 100 can also query a networked computer or other mobile device for a vibration pattern. If the selected vibration pattern does not reside on the mobile device 100, at 210, the selected vibration pattern can be transferred to the mobile device 100 from a networked computer or other mobile device if the vibration pattern resides on the networked computer or other mobile device. If the user does not select an existing vibration pattern, the user is prompted to create a vibration pattern at 220.

Referring now to FIG. 2B, an embodiment for creating a vibration pattern using vibration application 115 is depicted. Depending on the hardware of the vibration device 118 or haptic device 120, and the abilities of that hardware in the specific device, feedback can be set using a sliding scale of intensities, frequencies, and durations, or set from a predefined list. For example, similar to notes in a tune, a series of vibration “pulses” and pauses can be played in sequence to produce a vibration pattern. As further example, a user may prescribe a long gentle vibrate pulse, followed by two short strong vibration pulses with a short pause between them, and associate the pattern with a particular contact, message type or message type from a particular person, etc. It will be appreciated that a vibration pattern can be created on a separate computer or mobile device and transferred to mobile device 100, as described above with respect to the in-call application settings.

If the user indicates they wish to create a new vibration pattern, at 222, the user is prompted to start the pattern by adding a vibration pulse. If the user would like to add a vibration pulse, at 224, based on the device 100 and user preference, haptic or vibrate patterns can be implemented. At 226, the user can select the duration, intensity and direction with haptic hardware for the pulse. At 228, the user can select the duration and intensity with vibrate hardware for the pulse. At 230, the software saves the respective changes/modifications. If the user does not want to start the vibration pattern with a pulse, at 232 the user is prompted to add a pause, selectable by duration to an existing pattern. Once they have added the pulse or pause for the pattern, at 234, the user is prompted to add another pulse or pause until they have created the pattern they want.

When creating the pulses, the internal hardware determines the parameters available for customization to the user. If the internal hardware is a vibrator, the software determines if it has a pre-defined series of pulses set a build time, or whether the user can pick a vibration pulse along a sliding scale of intensities and durations. If the device has haptic internals, it is possible set the vibration variables along a sliding scale. Haptic devices may also be able to offer the user the ability to set the direction of the vibration—from the top to the bottom of the device for example. If the mobile device 100 does not include a vibration device 118, the haptic path is automatically followed. Likewise, if the mobile device 100 does not include a haptic device 120, the vibration path is automatically followed. If the mobile device has both, the default is to follow the path for creating haptic vibration patterns.

According to this embodiment, if the vibrate path is selected, at 232 default vibrate lengths and/or intensities are utilized by the mobile device 100 for a particular notification event. If the haptic path is selected, at 234 default vibrate lengths, intensities, and/or directions are utilized by the mobile device 100 for a particular notification event defined above. At 236, the user is prompted to edit or create a vibrate pattern, applicable to haptic and vibrate paths. If the user does not wish to edit or create a vibration pattern, at 224, the user has the option to add one or more pauses in the default haptic or vibrate patterns, as described above. If the user wishes to edit or create a custom vibration pattern, a haptic path or vibrate path can be selected.

It will be appreciated that if the vibrate path is selected, the user, using the vibration application 115 can create and/or edit vibrate patterns which are used by the mobile device 100 to control the operation of the vibration device 118. As described above, the vibration application 115 can be accessed from the mobile device 100 or another computer or mobile device. The user can select different intensities, frequencies, durations, pitch, etc. from a list of selections, which may be pre-defined. Alternatively, depending on the particular vibration device 118, the user can use a sliding scale or other means to define various vibrate intensities, frequencies, durations, pitch, etc. by sliding a slider along the scale or inputting numbers which correspond to a particular amount or level. For example, the user could string a short sharp vibrate with two slow, longer vibrations followed by a short slow vibration for a particular notification event, such as an incoming call from a particular contact. There are a myriad of possibilities available to the user of the mobile device 100. When the user considers the vibration pattern finished, the software then presents the user the option to save the vibration pattern by a specific name.

If the haptic path is selected, the user, using the vibration application 115 can create and/or edit haptic patterns which are used by the mobile device 100 to control the operation of the haptic device 120. As described above, the vibration application 115 can be accessed from the mobile device 100 or another computer or mobile device. The user can select different intensities, frequencies, durations, pitch, feedback direction (side to side, top to bottom, etc.) and the like from a list of selections. Alternatively, depending on the particular haptic device 120, the user can use a sliding scale or other means to define various intensities, frequencies, durations, pitches, and feedback directions by sliding a slider along the scale or by providing other input, such as a level or amount. When the user considers the haptic pattern finished, the software then presents the user the option to save the haptic pattern by a specific name.

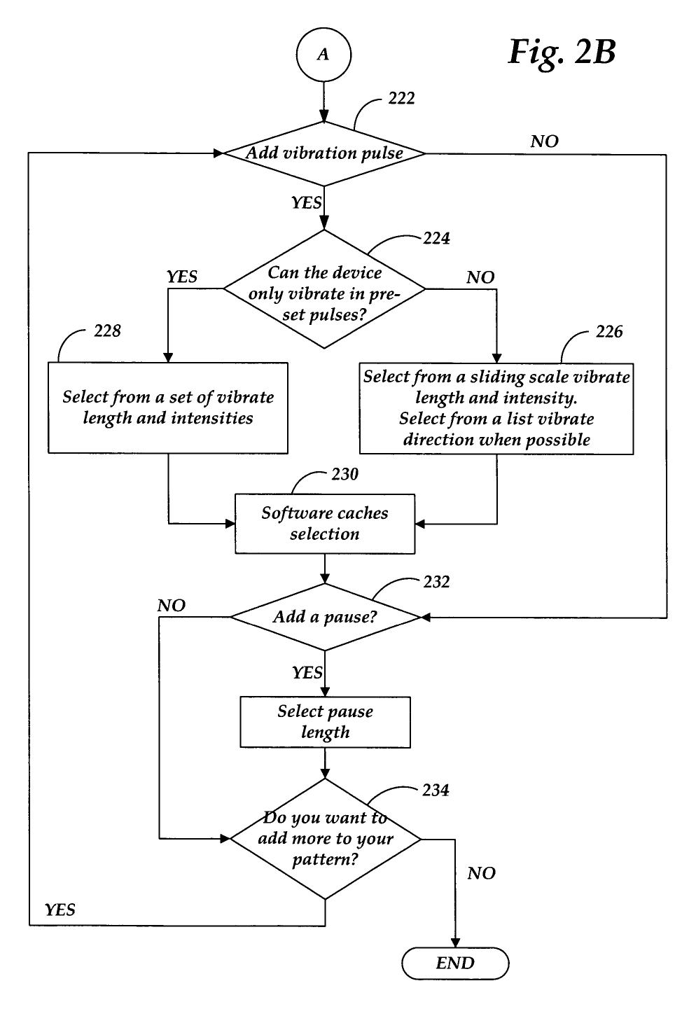

Referring now to FIG. 3, a flow diagram depicts an exemplary in-call experience for a user who has implemented an in-call profile. At 300, the mobile device 100 issued an alert according to a particular notification event received. As described above, alerts can issue based on a type of notification event, such as an incoming call, multimedia message service, short message service, instant message, voice message, text message, e-mail message, meeting reminder, page, message with attachment, message from a particular contact, emergency alert, connect/disconnect to a network (such as a WiFi network for example), etc. At 302, the mobile device 100 checks the radio interface 124 to determine if the user is currently in a call. The mobile device 100 can also check its operational state to determine if some other task is being performed or if the mobile device 100 is otherwise busy. For example, a user may be crafting an e-mail, reviewing a text message, changing device setting, etc. and the in-call or user profile can be used to react to these situations as well. For this example, a call situation is used to illustrate a user's in-call experience.

This example presumes that a user has created one or more in-call profiles and is implementing a particular in-call profile. When an alert is triggered during a call, at 300 the software checks to see if the alert is allowed to interrupt the call. If it is, at 304, the current in-call profile stored in memory 104 is checked to determine if an audio alert is to be used to alert the user according to the particular notification event. If so, the audio alert corresponding to the notification event is output from the mobile device 100 at the determined alert level. Exemplary audio alerts include beeps, polyphonic tunes etc. If not, at 306 the notification event is displayed on the display 106 and/or a vibrate alert is issued by the vibration device 118 or haptic device 120 according to the particular in-call profile in use and the flow ends at 308. It will be appreciated that based on the number of notification events presented during a call, multiple notification events may displayed on the display 106 at the end of a call.

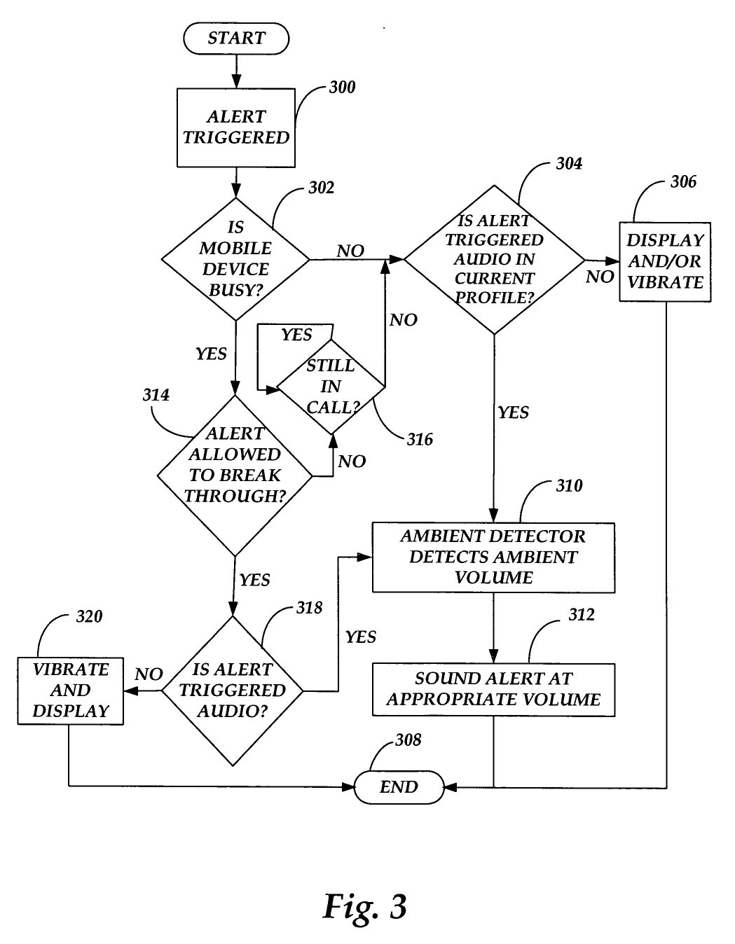

If an audio alert is to be used to alert the user to a particular notification event, at 310 the ambient noise detector 126 preferably detects the ambient volume associated with the user's location and/or interaction with the mobile device 100. Referring to FIG. 4, a mobile device 400 including an exemplary ambient noise detector 402 is depicted. The ambient noise detector 402 can be implemented using hardware and/or software and is preferably coupled with the mobile device's microphone 404 and ear speaker or external speaker 406. In this configuration, the ambient noise detector 402 can receive inputs associated with the ambient surroundings, such as ambient noise, user speech volume, etc., and adjust the audio output relative to the ambient surroundings at 312.

For example, the microphone 402 can receive input related to a very loud environment which is examined by the ambient noise detector 402. Based on the examination, the ambient noise detector 402 adjusts the amplitude of the audio alert relative to the input. The adjusted audio alert is then output to the user via speaker 406. The ambient noise detector 402 preferably adjusts the audio alert to a level at or above the detected ambient noise level so that the user always hears the audio alert. Thus, the ambient noise detector 402 tends to prevent the user from missing or unwittingly broadcasting audio alerts while using an in-call profile. The user can also disable the ambient noise detector 402 when creating a particular in-call profile.

If the user is in a call, at 314 the in-call profile is checked to determine if alerts are allowed to interrupt the call. If alerts are not allowed to interrupt the call, the flow proceeds to 316, and remains until the call ends, at which point the flow continues at 304. If alerts are allowed to interrupt the call, the flow proceeds to 318, and the in-call profile is checked to determine if an audio alert is to be used to alert the user according to the particular notification event. If so, the audio alert corresponding to the notification event is output from the mobile device 100 after ambient conditioning by the ambient noise detector (blocks 310-312). If not, at 320 a vibrate alert is issued by the vibration device 118 or haptic device 120 based on the notification event in accordance with the particular in-call profile in use and the notification event is displayed on the display 106, as a pop-up or icon for example. Thereafter, the flow ends at 308.

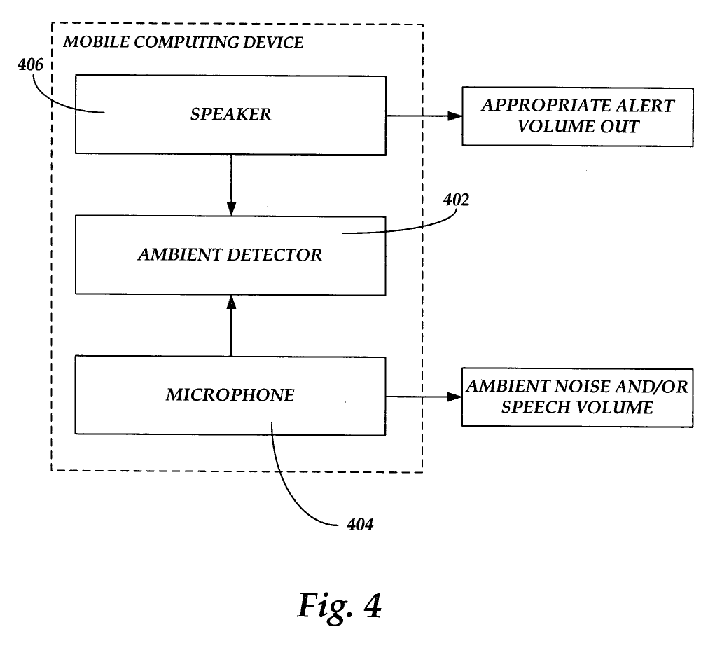

Referring now to FIG. 5, a block diagram of a mobile device 500 including an exemplary vibration device 502 is depicted. The mobile device 500 includes a vibration application 504 for controlling the operational characteristics of the vibration device 502. The exemplary vibration device 502 can be a discreet hardware component, installed near the speaker. Some vibration devices are pre-programmed with a set of vibration lengths and intensities at time of manufacture. For example, a vibration device may be pre-programmed to: vibrate short and soft; vibrate short and hard; vibrate long and soft; and/or vibrate long and hard, etc. More expensive vibration devices can have the vibration length, intensity, etc. manipulated and controlled using the vibration application 504. In some cases, the vibration application 504 can access pre-programmed vibrations, determining what's available, how to combine, and when to play which.

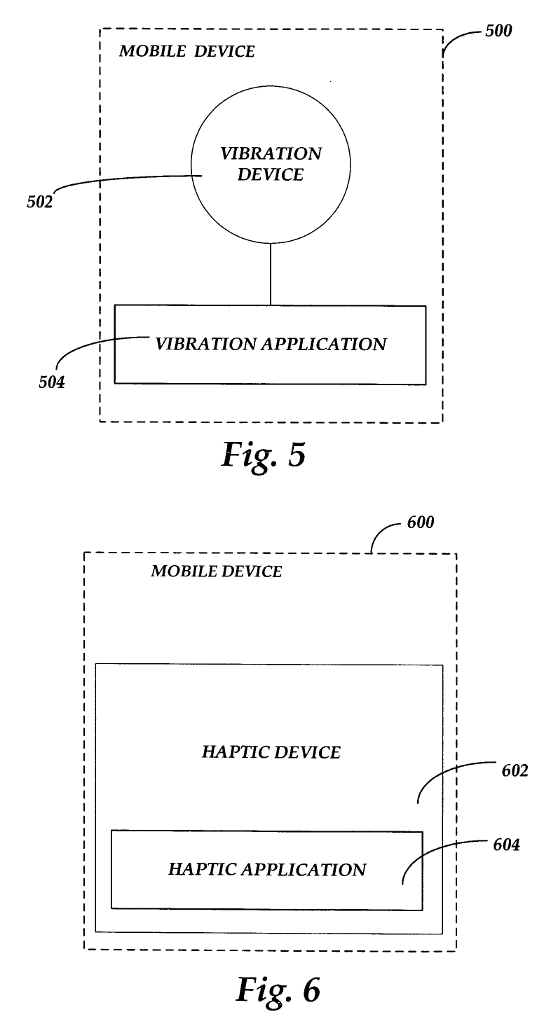

FIG. 6 is a block diagram of a mobile device 600 including an exemplary haptic device 602. The mobile device 600 includes a haptic application 604 for controlling the operational characteristics of the haptic device 602. The haptic device 602 typically extends across a portion of the mobile device 600 and can be manipulated and controlled using the haptic application 604 to vibrate in a spectrum of intensities, frequencies, directions, etc as described above. It will be appreciated that certain mobile devices include both haptic and vibration devices, or devices which operate with the both haptic and vibration characteristics, and the invention is not intended to be limited by any specific examples or embodiments discussed herein.

It should be appreciated that the logical operations of various embodiments of the present invention are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, logical operations including related algorithms making up the embodiments of the present invention described herein are referred to variously as operations, structural devices, acts or modules. It will be recognized by one skilled in the art that these operations, structural devices, acts and modules may be implemented in software, firmware, special purpose digital logic, and any combination thereof without deviating from the spirit and scope of the present invention as recited within the claims set forth herein.

Although the invention has been described in connection with various exemplary embodiments, those of ordinary skill in the art will understand that many modifications can be made thereto within the scope of the claims that follow. Accordingly, it is not intended that the scope of the invention in any way be limited by the above description, but instead be determined entirely by reference to the claims that follow.

What is claimed is:

1. A method for personalizing one or more alerts provided by a mobile device according to one or more notification events, the method comprising:
creating a user profile including associating one or more alerts with one or more notification events,
customizing the one or more alerts to provide personalized feedback when a particular notification event is acknowledged by the mobile device, and
if the user profile is activated, prioritizing the user profile when the mobile device acknowledges the one or more notification events.

2. The method of claim 1, further comprising customizing the one or more alerts to provide personalized feedback when a particular notification event is selected from the group consisting of an incoming call, a multimedia message service communication, a short message service communication, an instant message, a voice message, a text message, an e-mail message, a schedule reminder, a page, a message with an attachment, a message related a particular contact, information associated with a contact, an emergency alert, connect to a network, and disconnect from a network.

3. The method of claim 1, further comprising customizing the one or more alerts to include a vibrate pattern by providing a vibration intensity, frequency, pitch, or duration associated with a particular notification event.

4. The method of claim 1, further comprising customizing the one or more alerts to include a haptic pattern by providing a vibration intensity, direction, or duration associated with a particular notification event.

5. The method of claim 1, further comprising customizing the user profile using a remote computing device.

6. The method of claim 1, further comprising preventing a particular alert associated with a particular notification event from being communicated audibly or using vibration or haptic feedback when the mobile device is communicating with another computing device or processing other information.

7. The method of claim 6, further comprising informing the user of a missed alert associated with a notification event while the mobile device was communicating with another computing device or processing other information.

8. The method of claim 1, further comprising providing an audio alert at a level relative to ambient surroundings when the user profile is activated.

9. A computer-readable medium having computer executable instruction, which when executed by a computer, perform a method for personalizing one or more alerts provided by a mobile device according to one or more notification events, the method comprising:
creating a user profile including associating one or more alerts with one or more notification events,
customizing the one or more alerts to provide personalized feedback when a particular notification event is acknowledged by the mobile device, and
if the user profile is activated, prioritizing the user profile when the mobile device acknowledges the one or more notification events.

10. The computer-readable medium of claim 9, the method further comprising customizing the one or more alerts to provide personalized feedback when a particular notification event is selected from the group consisting of an incoming call, a multimedia message service communication, a short message service communication, an instant message, a voice message, a text message, an e-mail message, a schedule reminder, a page, a message with an attachment, a message related a particular contact, information associated with a contact, an emergency alert, connect to a network, and disconnect from a network.

11. The computer-readable medium of claim 9, the method further comprising customizing the one or more alerts to include a vibrate pattern by providing a vibration intensity, frequency, pitch, or duration associated with a particular notification event.

12. The computer-readable medium of claim 9, the method further comprising customizing the one or more alerts to include a haptic pattern by providing a vibration intensity, direction, or duration associated with a particular notification event.

13. The computer-readable medium of claim 9, the method further comprising preventing a particular alert associated with a particular notification event from being communicated audibly or using vibration or haptic feedback when the mobile device is communicating with another computing device or processing other information.

14. The computer-readable medium of claim 13, the method further comprising informing the user of a missed alert associated with a notification event while the mobile device was communicating with another computing device or processing other information.

15. The computer-readable medium of claim 11, the method further comprising providing an audio alert at a level relative to ambient surroundings when the user profile is activated.

16. A computing device operable to provide one or more customized alerts associated with one or more notification events, the computing device comprising:
means for creating a user profile including associating one or more alerts with one or more notification events,
means for customizing the one or more alerts to provide personalized feedback when a particular notification event is acknowledged by the computing device, and
means for prioritizing the user profile when the computing device acknowledges the one or more notification events when the user profile is activated, wherein the notification events are selected from the group consisting of an incoming call, a multimedia message service communication, a short message service communication, an instant message, a voice message, a text message, an e-mail message, a schedule reminder, a page, a message with an attachment, a message related a particular contact, information associated with a contact, an emergency alert, connect to a network, and disconnect from a network.

17. The computing device of claim 16 further operable to customize the one or more alerts to include a vibrate pattern by providing a vibration intensity, frequency, pitch, or duration associated with a particular notification event.

18. The computing device of claim 16 further operable to customize the one or more alerts to include a haptic pattern by providing a vibration intensity, direction, or duration associated with a particular notification event.

19. The computing device of claim 16 further operable to receive a customized user profile from another computing device.

20. The computing device of claim 16 further operable to provide an audio alert at a level relative to ambient surroundings when the user profile is activated.
